(19) United States
(12) Patent Application Publication
(10) Pub. No.: US 2008/0247591 A1
(43) Pub. Date: Oct. 9, 2008

(54) Earphone Jack

(76) Inventor: Johnson YANG, Jhonghe City (TW)

Correspondence Address: Dr. BANGER SHIA, 102 Lindencrest Ct., Sugar Land, TX, 77479-5201, US

(21) Appl. No.: 11/768,903

(22) Filed: Jun. 26, 2007

(30) Foreign Application Priority Data
Apr. 4, 2007 (TW) 096205527

(51) Int. Cl. H04R 25/00

(52) U.S. Cl. 381/384

(57) ABSTRACT

An earphone jack comprises a housing, at least one first contact member and one second contact member. A contact piece formed on the first contact member is elastically supported on a supporting portion of the second contact member and located a distance above the contact piece of the second contact member, so as to ensure a good signal transmission between the circuit and the earphone jack.

### BACKGROUND OF THE INVENTION

1. Field of the Invention

The present invention relates to an earphone jack, and more particularly to an earphone jack that provides a proper positioning effect and ensures a smooth signal transmission.

2. Description of the Prior Art

With the advancement of science and technology, portable digital electronic products are coming out one after another, and accordingly many peripheral products are also introduced continuously. Among them, earphone is a typical one, and the normal products are usually provided with an earphone jack for providing electric connection to the earphone. TW Pat. No. 86,216,574 discloses an earphone jack 10 (as shown in FIG. 1) comprising a housing 11, at least one first contact member 12 and at least one second contact member 13.

The housing 11 is axially formed with a socket 111 for in insertion of an earphone plug, and a slot 112 transversely passing through the socket 111. In either inner surface of the slot 112 is defined an inserting recess 113.

The first contact member 12 is formed with a downward extending leg 121. A contact piece 122 extends forward from the leg 121, and a downward piece 123 is formed at the upper end of the leg 121 and located opposite the contact piece 122.

The second contact member 13 is formed with a downward leg 131, and formed at the upper end of the second contact member 13 is a horizontal contact piece 132. This conventional earphone jack has the following disadvantages:

The contact piece 132 of the second contact member 13 is welded onto the circuit and forms a welding point of tin. The welding point blocks the downward piece 123 of the first contact member 12 from contacting the contact piece 132 of the second contact member 13, causing a short circuit of the contact piece 132 of the second contact member 13, so that the signal cannot be successfully transmitted from the earphone jack 10 to the circuit, leading to a poor signal transmission quality.

The present invention has arisen to mitigate and/or obviate the afore-described disadvantages.

### SUMMARY OF THE INVENTION

The primary objective of the present invention is to provide an earphone jack comprising: a housing, at least one first contact member and one second contact member. A contact piece formed on the first contact member is elastically supported on a supporting portion of the second contact member and located a distance above the contact piece of the second contact member, after the contact piece of the second contact member is welded, it will not affect the contact between the contact piece of the first contact member and the supporting portion of the second contact member, thus ensuring a good signal transmission between the circuit and the earphone jack and improving the quality of the product.

The secondary objective of the present invention is to provide an earphone jack comprising: a housing, at least one first contact member and one second contact member. The contact pieces of the first and second contact members are [symbol] -shaped and are inserted in the circuit to provide a positioning effect, thus preventing the occurrence of displacement of the first and second contact members, ensuring that the welding point is indeed connected and accordingly saving the cost of re-welding operation.

### BRIEF DESCRIPTION OF THE DRAWINGS

FIG. 1 is a cross sectional view of a conventional earphone jack;

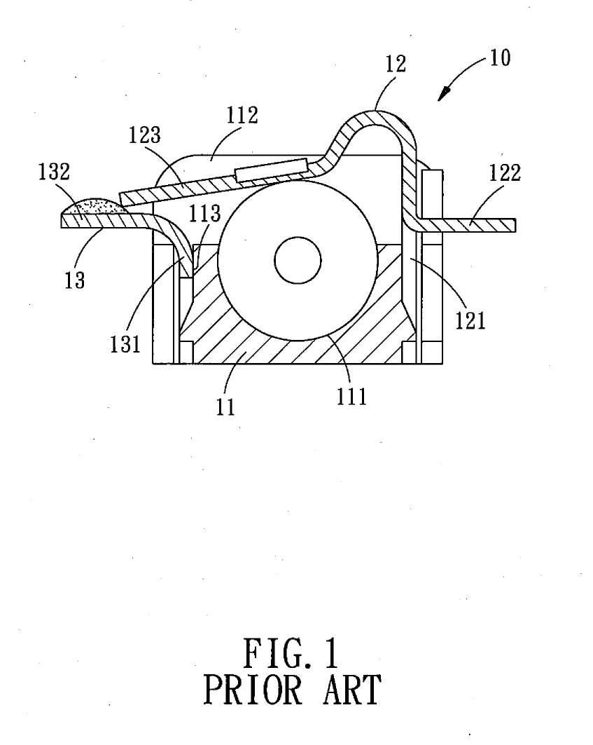

FIG. 2 is an exploded view of an earphone jack in accordance with the present invention;

FIG. 3 is another exploded view of the earphone jack in accordance with the present invention;

FIG. 4 is a perspective view of the earphone jack in accordance with the present invention;

FIG. 5 is an exploded view of the earphone jack in accordance with the present invention assembled with a circuit; and

FIG. 6 shows that the earphone jack in accordance with the present invention is assembled with a circuit.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

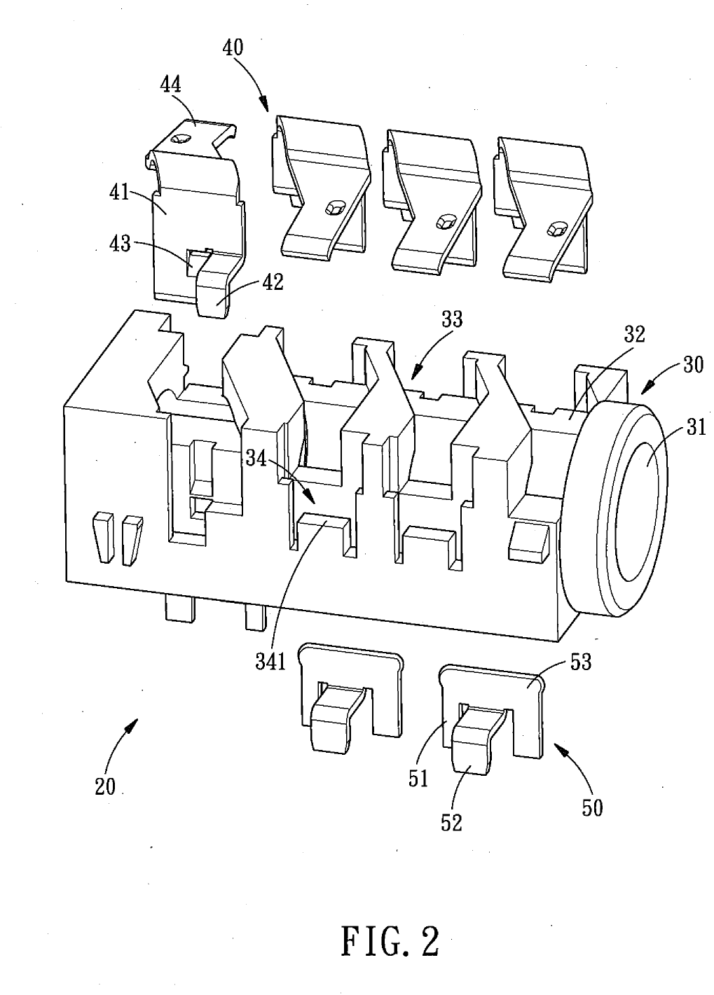

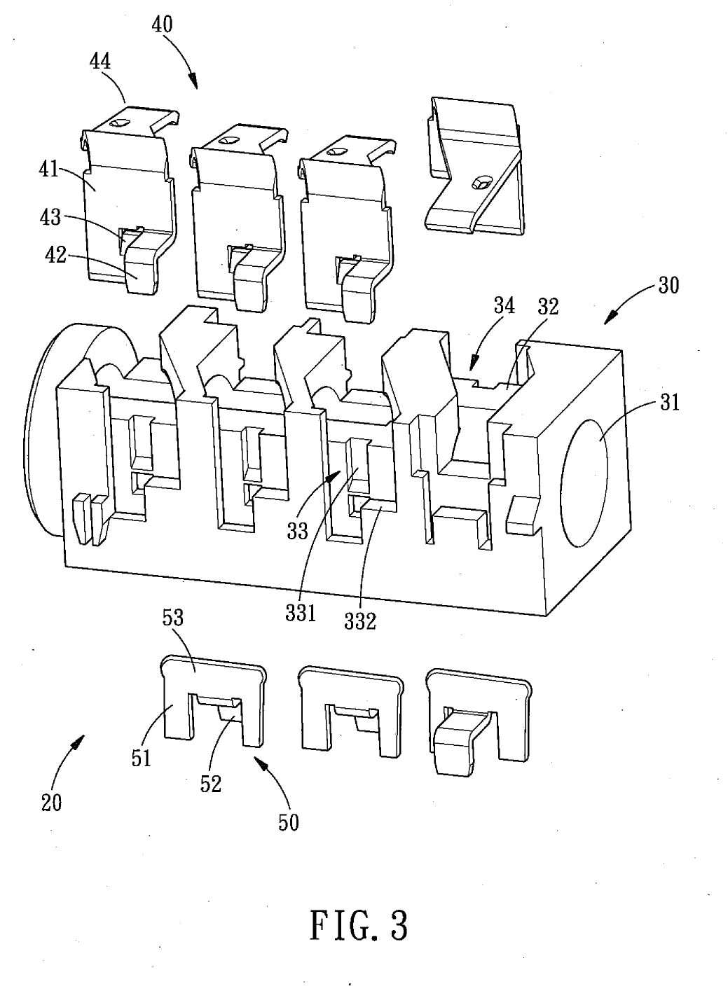

Referring to FIGS. 2 and 3, an earphone jack 20 in accordance with the present invention comprises: a housing 30, at least one first contact member 40 and at least one second contact member 50.

The housing 30 is axially formed with a socket 31 for insertion of an earphone plug. A groove 32 is defined at the top of the housing 30 and transversely passes over the socket 31. The groove 32 is Π-shaped and is formed in either inner surface thereof with an inserting recess 33, 34 for mating with the first and second contact members 40, 50, respectively. At the center of the inner surface of the inserting recess 33 is defined a positioning cavity 331. A contact portion 332 is formed on the outer surface of the inserting recess 33, and a contact portion 341 is formed at the center of the outer surface of the inserting recess 34.

The first contact member 40 is [symbol] -shaped and is formed at one side thereof with a leg 41 to be inserted in the inserting recess 33 of the housing 30, and on one side of the leg 41 is formed a [symbol] -shaped contact piece 42 for contacting the contact portion 332 in the inserting recess 33. A slant stopping piece 43 is formed beside the contact piece 42 and is to be engaged in the positioning cavity 331 of the inserting recess 33. The first contact member 40 is formed on the other side thereof with a conductive piece 44 to be inserted in the groove 32 of the housing 30.

The second contact member 50 is rectangular-shaped and is formed at the lower end thereof with a leg 51 to be inserted in the inserting recess 34 of the housing 30. A [symbol] -shaped contact piece 52 is formed at the center of the leg 51 for contacting the contact portion 341 of the inserting recess 34, and a supporting portion 53 for contacting the conductive piece 44 of the first contact member 40 is formed on the top of the second contact member 50.

The relative positions and structures of the respective components of the embodiment of the present invention are briefly described as above.

For a better understanding of the present invention, its operation and function, reference should be made to FIGS. 2-6.

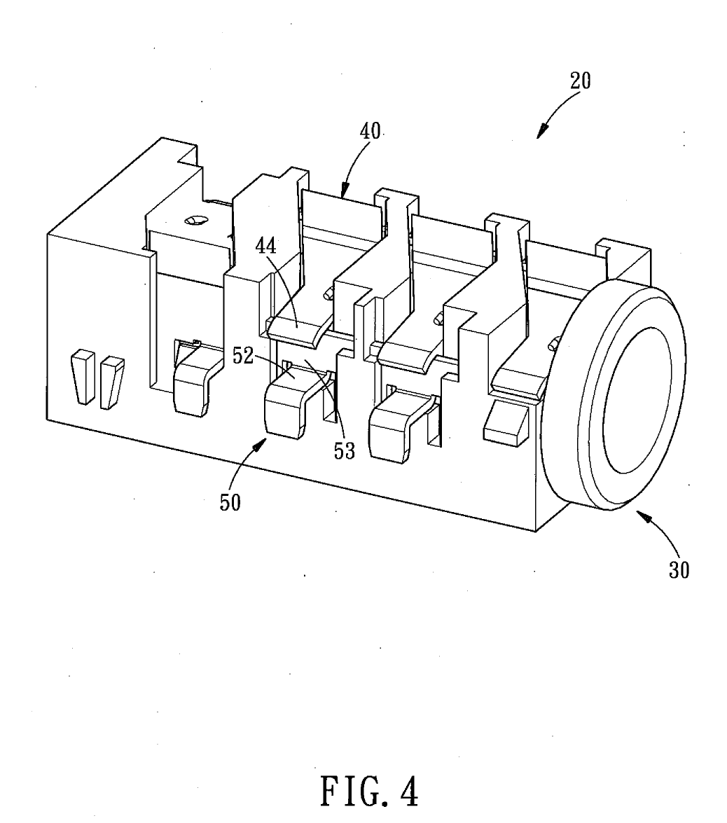

In assembly, the leg 51 of the second contact member 50 (as shown in FIG. 2) is inserted in the inserting recess 34 of the housing 30, and the contact piece 52 of the second contact member 51 is in contact with the contact portion 341 of the inserting recess 34. The leg 41 of the first contact member 40 (as shown in FIG. 3) is inserted in the inserting recess 33 of the housing 30, the contact piece 42 of the first contact member 40 is in contact with the contact portion 332 of the inserting recess 33, the stopping piece 43 of the first contact piece 40 is engaged in the positioning cavity 331 of the inserting recess 33, and the end of the conductive piece 44 of the first contact member 40 (as shown in FIG. 4) contacts the supporting portion 53 of the second contact member 50, so that the conductive piece 44 of the first contact member 40 is elastically disposed in the groove 32 of the housing 30.

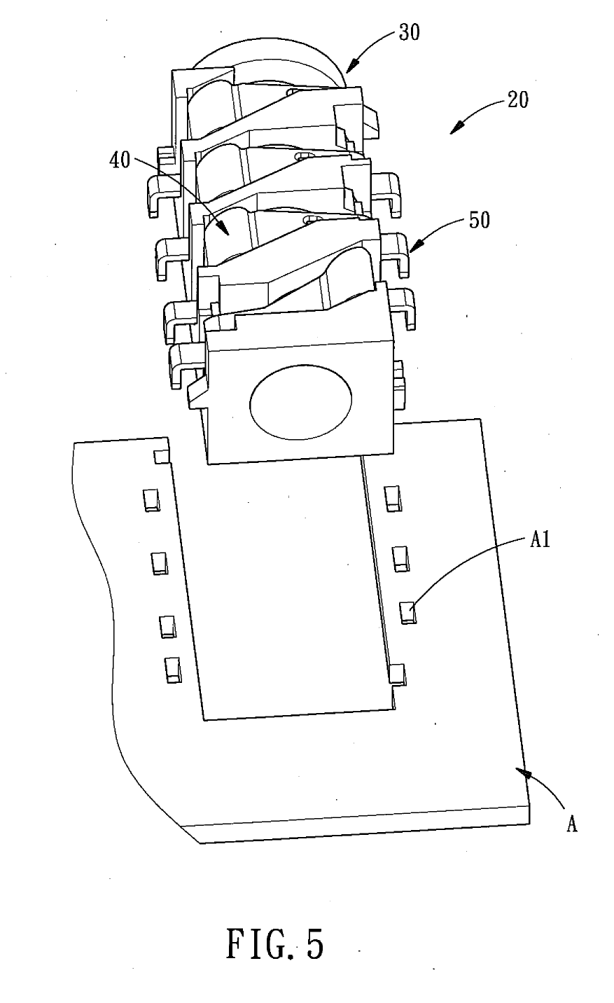

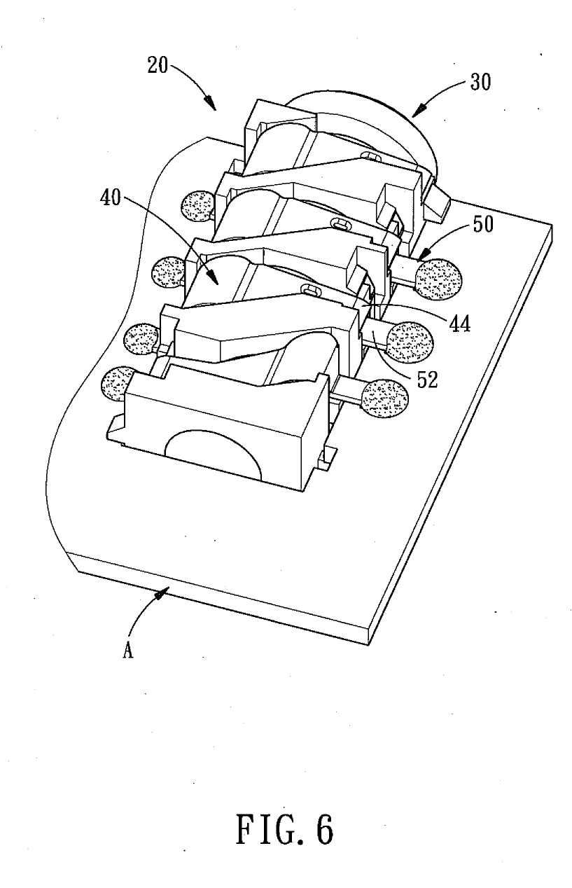

In addition, a circuit A (as shown in FIG. 5) is assembled with the earphone jack 20 and is defined with a plurality of sockets Al for mating with the contact pieces 42, 52 of the first and second contact members 40, 50, so as to provide a first positioning effect. And then the contact piece 42 of the first contact member 40 (as shown in FIG. 6) and the contact piece 52 of the second contact member 52 are welded to the circuit A, respectively, to provide a second positioning effect. The present invention has the following advantages after analyzing the assembly structure as described above:

The conductive piece 44 of the first contact member 40 is elastically supported on the supporting portion 53 of the second conductive member 50 and is located a distance above the contact piece 52 of the second contact member 50. After the contact piece 52 of the second contact member 50 is welded, it will not affect the contact between the contact piece 44 of the first contact member 40 and the supporting portion 53 of the second contact member 50, thus ensuring a good signal transmission between the circuit A and the earphone jack 20 and improving the quality of the product.

In addition, the contact pieces 42 and 52 of the first and second contact members 40, 50 are both [symbol] -shaped and are inserted in the circuit A to provide a positioning effect, thus preventing the displacement of the first and second contact members 40 and 50, ensuring that the welding point is indeed connected and accordingly saving the cost of re-welding operation.

To summarize, the earphone jack of the present invention comprises: a housing, at least one first contact member and one second contact member. A contact piece formed on the first contact member is elastically supported on a supporting portion of the second contact member and located a distance above the contact piece of the second contact member, so as to ensure a good signal transmission between the circuit and the earphone jack.

While we have shown and described various embodiments in accordance with the present invention, it is clear to those skilled in the art that further embodiments may be made without departing from the scope of the present invention.

What is claimed is:

1. An earphone jack comprising a housing axially formed with a socket for insertion of an earphone plug, at least one groove defined at a top of the housing and transversely passing over the socket, the groove being formed in either inner surface thereof with an inserting recess for mating with the first and second contact members, respectively; wherein
the first contact member is formed at one side thereof with a leg to be inserted in a first one of the inserting recesses of the housing, and on one side of the leg is formed a contact piece for contacting the first one of the inserting recesses, the first contact member is formed on the other side thereof with a conductive piece to be inserted in the groove of the housing;
the second contact member is formed at a lower end thereof with a leg to be inserted in a second one of the inserting recesses of the housing, a supporting portion is formed on the top of the second contact member, the conductive piece of the first contact member is elastically supported on the supporting portion of the second contact member and is located a distance above a contact piece of the second contact member.

2. The earphone jack as claimed in claim 1, wherein a positioning cavity is formed in an inner surface of the first one of the inserting recesses, a contact portion is formed on an outer surface of the first one of the inserting recesses, a contact portion is formed on an outer surface of the second one of the inserting recesses, the contact piece of the first contact member contacts the contact portion of the first one of the inserting recesses, a stopping piece is formed beside the contact piece of the first contact member and is to be engaged in the positioning cavity of the first one of the inserting recesses, the contact piece of the second contact member contacts the contact portion of the inserting recesses of the first contact member.

3. The earphone jack as claimed in claim 1, wherein the first contact member is [symbol] -shaped.

4. The earphone jack as claimed in claim 1, wherein the second contact member is rectangular-shaped.

5. The earphone jack as claimed in claim 1, wherein the groove is Π-shaped.

6. The earphone jack as claimed in claim 1, wherein the contact piece of the first contact member is [symbol] -shaped.

7. The earphone jack as claimed in claim 1, wherein the contact piece of the second contact member is [symbol] -shaped.
